(19) United States
(12) Patent Application Publication
(10) Pub. No.: US 2024/0153440 A1
(43) Pub. Date: May 9, 2024

(54) INTERLEAVING DRIVING METHOD OF LIGHT EMITTING DIODE ARRAY AND LIGHT EMITTING DIODE DEVICE

(71) Applicant: MACROBLOCK,INC., Hsinchu City (TW)

(72) Inventors: Kai En LIN, Hsinchu City (TW); Che Wei CHANG, Hsinchu City (TW); Ming Jia WU, Hsinchu City (TW)

(73) Assignee: MACROBLOCK,INC., Hsinchu City (TW)

(21) Appl. No.: 18/119,694

(22) Filed: Mar. 9, 2023

(30) Foreign Application Priority Data
Nov. 9, 2022 (TW) 111142817

(51) Int. Cl. G09G 3/32

(52) U.S. Cl. CPC G09G 3/32; G09G 2310/027; G09G 2310/08; G09G 2320/0233

(57) ABSTRACT

An interleaving driving method of light emitting diode array comprises: receiving image signal; converting the image signal into gray scale signals, the gray scale signals correspond to the plurality of light emitting channels, respectively, to execute multiple steps. The multiple steps include: generating a high gray scale data group and a low gray scale data group; when there is data in the high gray scale data group, drive the light emitting diode channel corresponding to the target gray scale signal during a first turn on time interval; when there is data in the low gray scale data group, drive the light emitting diode channel corresponding to the target gray scale signal during a second turn on time interval which does not overlap the first turn on time interval and a first gray scale signal and a second gray scale signal of the gray scale signals does not overlap each other.

### CROSS-REFERENCE TO RELATED APPLICATIONS

This non-provisional application claims priority under 35 U.S.C. § 119(a) on Patent Application No(s). 111142817 filed in Taiwan (R.O.C) on 2022 Nov. 9, the entire contents of which are hereby incorporated by reference.

### BACKGROUND

### 1. Technical Field

This disclosure relates to a driving method of light emitting diode array, especially an interleaving driving method of light emitting diode array.

### 2. Related Art

A light-emitting diode passive array is composed by intersecting scan lines and driving lines. Each of the scan lines has a common switch, and the light emitting diode scan line which will perform display is determined by a driving integrated circuit. Each of the driving lines has a constant current source, and the luminance of the diode is controlled by adjusting the time that the constant current source is turned on. Because the same scan line can only act in one unit time and the light emitting diode on the line has different luminance, which causes the timing that the constant current source is turned on to be different. The luminance adjustment of the light emitting diode passive array may be realized by changing the driving time of the constant current source in one unit time. The higher the requirement is for gray scale for the light emitting diode, the longer the driving current is turned on in one unit time; and the lower the requirement is for gray scale, the shorter the driving current is turned on in one unit time.

Luminance control is important for light emitting diode passive array, and the luminance has to be adjusted according to different instances. However, in a case of low gray scale (luminance is low), where the light emitting diode screen is displaying image, if the image remains the same, then the constant current sources will act at the same time; but when the image changes, the act of the constant current sources will change with the image and causes the driving timing of the constant current sources and number of constant current sources differ. In the case above, the area with low luminance can be easily effected by the area with high luminance, which causes an inconsistency problem of the displayed luminance and the displayed color, and this problem is defined as “coupling”.

### SUMMARY

Accordingly, this disclosure provides an interleaving driving method of light emitting diode array and light emitting diode device.

According to one embodiment of this disclosure, an interleaving driving method of light emitting diode array is adapted to a light emitting diode array, and includes multiple light emitting diode channels. The interleaving driving method of light emitting diode array includes receiving an image signal; converting the image signal into gray scale signals corresponding to light emitting diode channels, respectively; and use each of the gray scale signals as a target gray signal to execute: generating a high gray scale data group and a low gray scale data group according to a preset threshold and the target gray scale signal; when there is data in the high gray scale data group, drive the light emitting diode channels corresponding to the target gray signal in the light emitting diode channels during the first turn on time interval according to the high gray scale data group; and when there is data in the low gray scale data group, drive the light emitting diode channel corresponding to the target gray scale signal during the second turn on time interval, wherein the first turn on time interval does not overlap the second turn on time interval and the gray scale signals include a first gray scale signal and a second gray scale signal, and the second turn on time interval corresponding to the first gray signal does not overlap the second turn on time interval corresponding to the second gray signal.

According to one embodiment of this disclosure, a light emitting diode device includes a light emitting diode array, a current driving circuit, and a processing control circuit. The light emitting diode array includes light emitting diode channels. The current driving circuit is connected to the light emitting diode array. The processing control circuit is connected to the current driving circuit, and is used to receive an image signal, convert the image signal into gray scale signals corresponding to the light emitting diode channel, respectively, and use each of the gray scale signals as a target gray scale signal to execute: generating a high gray scale data group and a low gray scale data group according to a preset threshold and the target gray scale signal; when there is data in the high gray scale data group, drive the light emitting channel corresponding to the target gray scale signal in the light emitting channels with the current driving circuit in the first turn on time interval according to the high gray scale data group; and when there is data in the low gray scale data group, drive the light emitting diode channel corresponding to the target gray scale signal with the current driving circuit during the second turn on time interval; wherein the first turn on time interval does not overlap the second turn on time interval and the gray scale signals include a first gray scale signal and a second gray scale signal, and the second turn on time interval corresponding to the first gray signal does not overlap the second turn on time interval corresponding to the second gray signal.

In summary, the present invention can reduce color shift and light brighten of the low gray scale screen by interleaving displaying low gray scale data and high gray scale data of the light emitting diode array, thereby increasing the contrast of the light emitting diode array.

In view of the above description, and the description of the embodiments below are used to demonstrate and explain the spirit and principle of the present invention, and provide a further explanation of the claimed scope of the present invention.

### BRIEF DESCRIPTION OF THE DRAWINGS

The present disclosure will become more fully understood from the detailed description given below and the accompanying drawings which are given by way of illustration only and thus are not limitative of the present disclosure and wherein:

FIG. 1 is a block diagram illustrating the light emitting diode device according to an embodiment of the present invention;

FIG. 2 is a block diagram illustrating the processing control circuit and the current driving circuit according to an embodiment of the present invention;

FIG. 3 is a flow diagram illustrating the interleaving driving method of light emitting diode array according to an embodiment of the present invention;

FIG. 4 is a timing diagram illustrating a normal driving method of light emitting diode array;

FIG. 5 is a timing diagram illustrating the interleaving driving method of light emitting diode array according to an embodiment of the present invention; and

FIG. 6 is a timing diagram illustrating the interleaving driving method of light emitting diode array according to another embodiment of the present invention.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

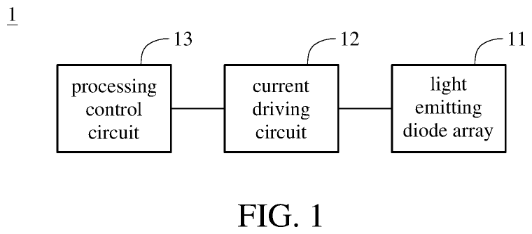

Please refer to FIG. 1 which is a block diagram illustrating the light emitting diode device according to an embodiment of the present invention. As shown FIG. 1, the light emitting diode device 1 includes a light emitting diode array 11, a current driving circuit 12, and a processing control circuit 13, wherein the current driving circuit 12 is electrically connected to the light emitting diode array 11 and the processing control circuit 13. The light emitting diode array 11 includes a plurality light emitting diode channels and is configured to display image, each of the diode channels includes a plurality light emitting diodes. The current driving circuit 12, for example, includes a plurality constant current sources, wherein the constant current sources and the light emitting diode channels may have an one on one relationship, and can be controlled by the processing control circuit 13 to drive the corresponding light emitting channel.

The processing control circuit 13 may be implemented as, for example, a micro controller or an integration of multiple micro controllers, and is configured to receive an image signal, convert the image signal into gray scale signals corresponding to light emitting diode channels respectively, and use each of the gray scale signals as a target gray scale signal divided as a high gray scale signal group and a low gray scale signal group, and control the current driving circuit 12 to drive the light emitting diode array 11 with an interleaving method according to the high gray scale data group and the low gray scale data group. Specifically, the processing control circuit 13 controls the current driving circuit 12 to drive the light emitting array 11 with the scrambled pulse-width modulation. The operation flow of the processing control circuit 13 will be described in detail in the later parts of the description.

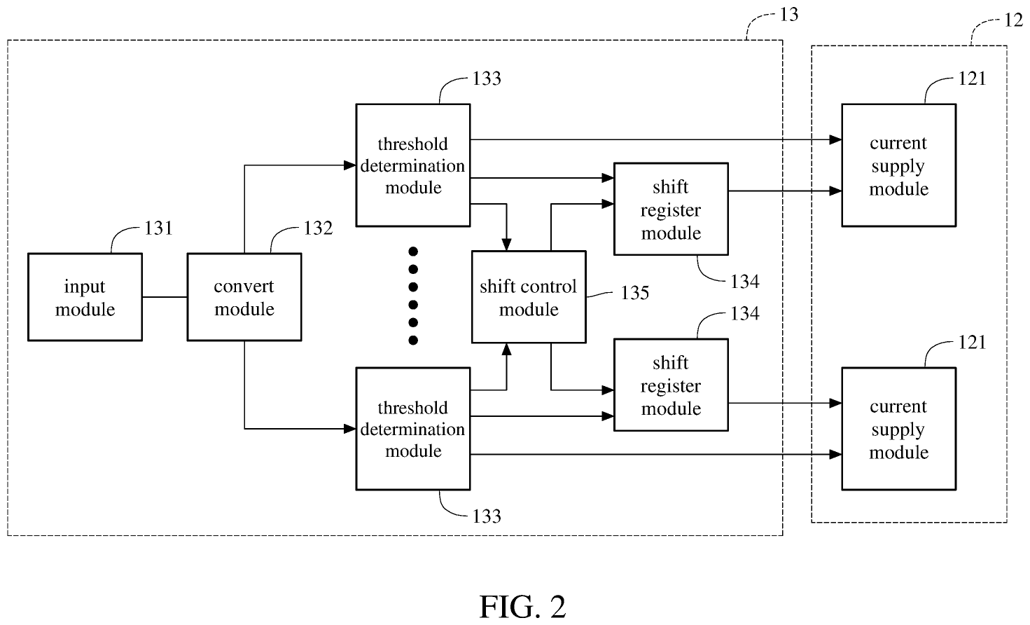

Please refer to FIG. 2, which is a block diagram illustrating the processing control circuit and the current driving circuit according to an embodiment of the present invention. As shown in FIG. 2, the current driving circuit 12 may include a plurality of current supply modules 121 corresponding to the light emitting diode channels of the light emitting diode array, respectively. The processing control circuit 13 may include an input module 131, a convert module 132, a plurality of threshold determination modules 133, a plurality of shift register modules 134, and a shift control module 135.

The input module 131 is connected to the convert module 132 and is configured to receive image signal.

The convert module 132 is connected to the plurality of threshold determination modules 133 and is configured to convert the image signal received from the input module 131 into gray scale signals which correspond to the light emitting diode channels, respectively.

Each of the plurality of threshold determination modules 133 is connected to the shift register module 134, the shift control module 135, and the current supply module 121. Specifically, the threshold determination module 133, the shift register module 134, the current supply module 121, and the light emitting diode channel are in an one on one corresponding relationship. Each of the plurality of threshold determination modules 133 may use each of the gray scale signals received from the convert module 132 as a target gray scale signal, and generate a high gray scale data group and a low gray scale data group according to a preset threshold and the target gray scale signal, wherein if there is data in the high gray scale signal group, the threshold determination module 133 may directly transfer the high gray scale data group to the current supply module 121 in the current driving circuit 12 during the first turn on time interval to drive the corresponding light emitting diode channel through the current supply module 121.

The shift register module 134 is electrically connected to the current supply module 121 and the shift control module 135, and is configured to receive data from the threshold determination module 133 and perform timing shift on the data.

The shift control module 135 is configured to adjust the parameter of each shift register module 134 independently according to the determination result of the threshold determination module 133 to adjust the delay parameter of the current supply module 121, that is to move the second turn on time interval to before the first turn on time interval or delay the second turn on time interval to after the first turn on time interval, so that the data (which is low gray scale data) in the low gray scale data groups can be transferred to the current supply module 121 during the second turn on time interval which is different from the first turn on time interval.

For example, assuming that a frame is divided into a plurality of unit time intervals, in the case of one light emitting diode channel, when there is data in both the high and low gray scale groups, the threshold determination module 133 may transfer the data in the high gray scale data group to the current supply module 121 during one unit time interval (for example, the first unit time interval) to drive the light emitting diode array. The shift register module 134 may shift the low gray scale data to another unit time interval (for example, the last (final) unit time interval) that is different from the unit time interval which the high gray scale data is transmitted according to the control of the shift control module 135, wherein the amount of unit time intervals can be designed as needed, the present invention is not limit to thereof.

However, a case where there is no data in the high gray scale data group or the low gray scale data group may occur. When only the low gray scale data group has data, the light emitting display device independently executes the operation which low gray scale data passes through the shift register 134. In contrary, when only the high gray scale data group has data, then the light emitting display device independently executes the operation where the high gray scale data is directly sent to the current supply module 121 by the threshold determination module 133.

In an embodiment, the modules mentioned above may be programs pre-stored in a micro controller. In another embodiment, the input module 131 and the convert module 132 may be integrated as one micro controller, each of the threshold determination modules 133 may be a microcontroller and each of the shift register modules 134 may be a shift register. The modules mentioned above may be an integration of other numbers of micro controllers, the present invention is not limited thereof.

Furthermore, the first turn on time interval of any one of the gray scale signals may not overlap the second turn on time interval of any one of the gray scale signals. That is, the high gray scale data of any one of the light emitting diode channels and the low gray scale data of any channel may be supplied to the respective corresponding current supply module 121 during two different and non-overlapping time section. Take the aforementioned example of a frame being divided into multiple unit time intervals for example, all the threshold determination module(s) 133 with the determination result of having high gray scale data group may transfer the high gray scale data to the respective corresponding current supply module 121 in one unit time interval, and all the threshold determination module(s) 135 with the determination result of having low gray scale data group may transfer the low gray scale data group to the respective corresponding current supply module 121 in another unit time interval through the shift register module 134 with the parameter set by the shift control module 135, wherein said another unit time interval is different from the time interval mentioned above where the high gray scale data is transferred.

Moreover, assuming that the gray scale signals include a first gray signal and a second gray scale signal, the second turn on time interval corresponding to the low gray scale signal of the first gray scale signal may not overlap the second turn on time interval corresponding to the low gray scale signal of the second gray scale signal. That is, the low gray scale data of the light emitting diode channel of the first gray scale signal and the second gray scale signal are provided to the respective corresponding current supply module 121 during different and non-overlap time sections. Specifically, the low gray scale data of the light emitting diode channel of the first gray scale signal and the low gray scale data of the light emitting diode channel of the second gray scale signal may be provided to the respective corresponding current supply module 121 in different second turn on time intervals through independently controlling the parameter of each of the shift register module 134 by using the shift control module 135 according to the result of the threshold determination module 133. Take the aforementioned example of a frame being divided into multiple unit time intervals for example, at least two pieces of low gray scale data may be provided to the respective current supply modules 121 during two different second turn on time intervals in the same unit time interval (for example, the last (final) unit time interval).

That is, in the case of at least two channels of the light emitting diode device having low gray scale data, the low gray scale signal may be output during two different second turn on time intervals. Furthermore, except for the first gray scale signal and the second gray scale signal, the gray scale signals mentioned above may further include a third gray scale signal, and the low gray scale data of the third gray scale signal may be output during it's corresponding second turn on time interval, wherein the second turn on time interval corresponding to the low gray scale data of the third gray scale signal may be set to be the same as one of the second turn on time intervals of the first gray scale signal or the second gray scale signal by the shift control module 135; alternatively, the second turn on time interval corresponding to the low gray scale data of the third gray scale signal may be set to be another second turn on time interval which is different from the second turn on time intervals of the first gray scale signal and the second gray scale signal.

Also, the starting time of the first turn on time interval of the first gray scale signal may be the same as the starting time of the first turn on time interval of the second gray scale signal. That is, the high gray scale data groups of different gray scale data may be turned on during a same and overlapped time section. Take the aforementioned example of a frame being divided into multiple unit time intervals, all of the threshold determination module(s) 133 with the determination of having high gray scale data group may start transferring the high gray scale data to respective corresponding current supply module 121 at the same time point during the first unit time interval.

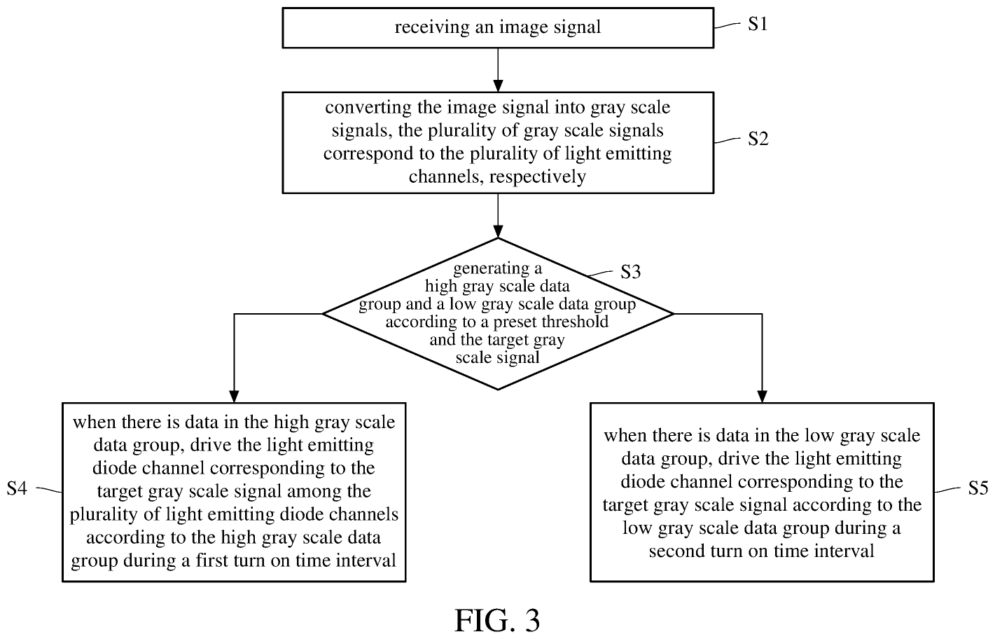

Please refer to FIG. 3, which is a flow diagram of the interleaving driving method of light emitting diode array according to an embodiment of the present invention.

As shown in FIG. 3, the interleaving driving method of light emitting diode array includes: step S1: receiving an image signal; step S2: converting the image signal into gray scale signals which corresponds to the light emitting diode channels, respectively; step S3: generating high gray scale data groups and low gray scale data groups according to the preset threshold and the target gray scale signal; step S4: when there is data in the high gray scale data group, drive the light emitting diode channel corresponding to the target gray scale signal among the plurality of light emitting diode channels during a first turn on time interval; and step S5: when there is data in the low gray scale data group, drive the light emitting diode channel corresponding to the target gray scale signal during a second turn on time interval.

The interleaving driving method of light emitting diode array may be applied to the light emitting diode device shown in FIG. 1 and FIG. 2, the operation of light emitting diode device 1 may be schematically used to describe each step shown in FIG. 3.

In step S1, the input module 131 in the processing control circuit 13 of the light emitting diode device 1 may receive an image signal.

In step S2, the convert module 132 in the processing control circuit 13 of the light emitting diode device 1 may convert the image signal into gray scale signals, wherein the gray scale signals correspond to the light emitting diode channels, respectively.

In step S3, the plurality of threshold determination modules 133 in the processing control circuit 13 of the light emitting diode device 1 may generate high gray scale data group and low gray scale data group according to the preset threshold value and target gray scale value.

Moreover, each of the plurality of threshold determination modules 133 of the processing control circuit 13 may divide the gray scale value of the target gray scale signal by the preset threshold value to generate a quotient value and a residual value, generate the high gray scale data group with the quotient value and the preset threshold value, and generate the low gray scale data group with the residual value. A specific method of generating the high and low gray scale data groups is shown in table 1, wherein table 1 is a case that the preset threshold value is 16T, but the preset threshold value may be set to other value as needed, the present invention is not limited thereof. T relates to the resolution or the luminance of the screen, for example, if the screen is a 12 BIT system, then there is a total of 4096 stages of luminance, which is 0T to 4095T, wherein 1T may be obtained by dividing a screen time by 4095. The BIT numbers represent color layers, the higher the BIT numbers are, the more gray scales there are, and also more meticulous and bright the colors are.

TABLE 1

| input | High gray scale data group | Low gray scale data group |
|---|---|---|
| 1T | 0 | 1T |
| 2T | 0 | 2T |
| 15T | 0 | 15T |
| 16T | 16T | 0 |
| 33T | 32T | 1T |
| 34T | 32T | 2T |
| 47T | 32T | 15T |

In step S4, where there is data in the high gray scale data group, each of the plurality of threshold determination modules 133 in the processing control circuit 13 of the light emitting diode device 1 may drive the light emitting diode channel corresponding to the target gray scale signal among the light emitting diode channels according to the high gray scale data group during the first turn on time interval, wherein the plurality of threshold determination modules 133 may transfer the high gray scale data to the current supply module 121 in the current driving circuit 12 to drive the corresponding light emitting diode channels in the light emitting diode array 11.

In step S5, when there is data in the low gray scale data group, the plurality of threshold determination modules 133 in the processing control circuit 13, the plurality of shift register modules 134, and shift control module 135 of the light emitting diode device 1 may drive the light emitting diode channel corresponding to the target gray scale signal according to the low gray scale data group during the second turn on time interval, wherein the plurality of threshold determination modules 133 may transfer the low gray scale data to the shift register module 134, and the shift register module 134 outputs the low gray scale data during the second turn on time interval according to the parameter set by the shift control module 135, and the second turn on time intervals of the low gray scale signals may overlap or not overlap with each other, and especially, at least two of them are not overlapped.

In brief, when the target gray scale signal has both the gray scale signal and low gray scale signal, both step S4 and step S5 may be performed; when there is only high scale data in the target gray scale signal, only step S4 may be performed; and when there is only low gray scale data in the target gray scale signal, only step S5 may be performed. The arrangement of the turn on time section of the low gray scale data and high gray scale data may be the same as the embodiments mentioned above, its description is not be repeated herein.

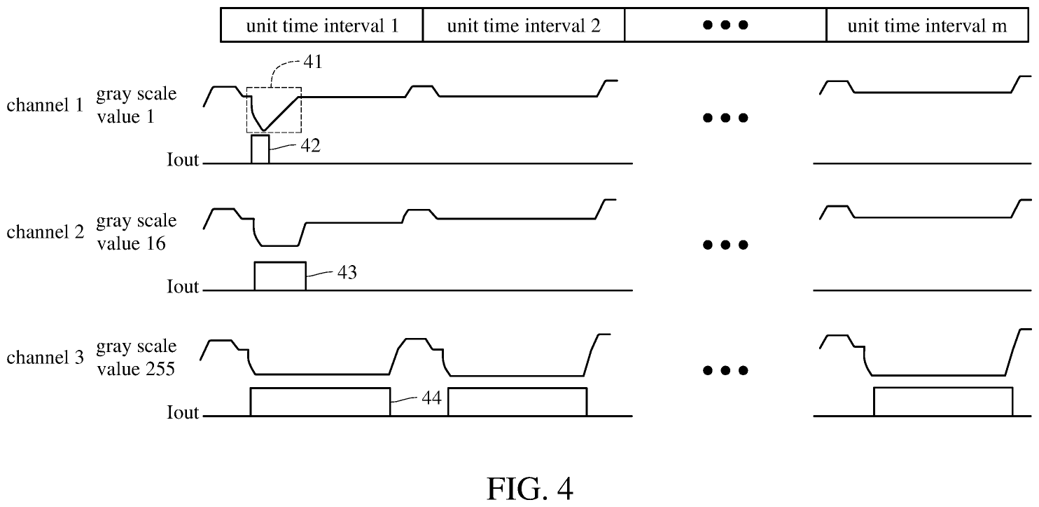

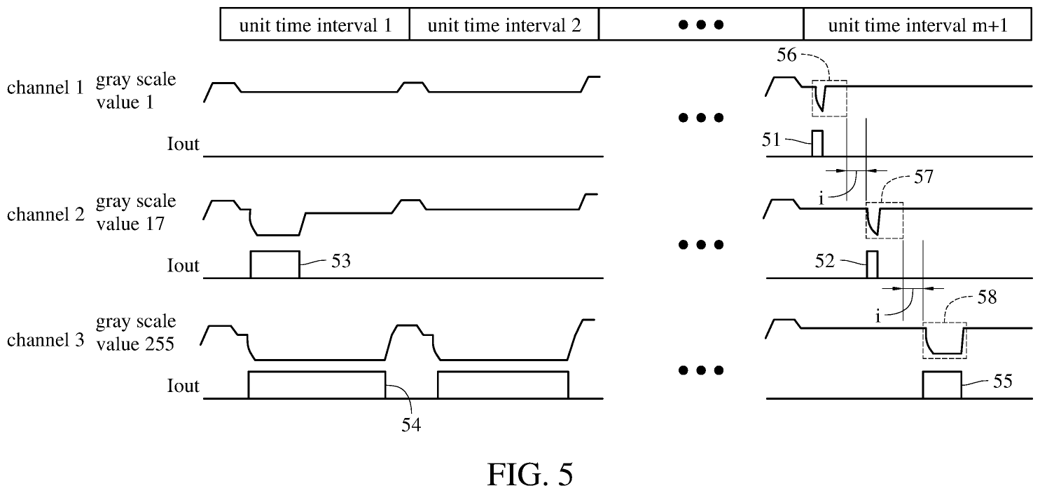

Please refer to both FIG. 4 and FIG. 5, FIG. 4 is a timing diagram illustrating a normal driving method of light emitting diode array and FIG. 5 is a timing diagram illustrating the interleaving driving method of light emitting diode array according to an embodiment of the present invention.

As shown in FIG. 4 and FIG. 5, in the timing diagram of a normal driving method of light emitting diode array illustrated in FIG. 4, the current 42 of gray scale data corresponding to the gray scale value being 1 in channel 1, the current 43 of gray scale data corresponding to the gray scale value being 16 in channel 2, and the current 44 of gray scale corresponding to the gray scale value being 255 in channel 3 start to turn on in the same unit time interval. In contrary, in the timing diagram illustrating the interleaving driving method of light emitting diode array according to an embodiment of the present invention shown in FIG. 5, the current 51 of the low gray scale data corresponding to the gray scale value being 1 in channel 1, the current 52 of the low gray scale data corresponding to the gray scale value being 17 in channel 2, and the current 55 of the low gray scale data corresponding to the gray scale value being 255 in channel 3 are turned on during unit time interval m+1 which is different from the unit time interval of the high gray scale data current 53 and 54 and has the second turn on time intervals not overlapping with each other. Specifically, the interleaving driving method of light emitting diode array shown in FIG. 5 has one more unit time interval divided from one frame compared to the normal driving method of light emitting diode array shown in FIG. 4, and the second turn on time intervals of the low gray scale data group can be set in the extra unit time interval to supply low gray scale data current to the corresponding channel, respectively. Furthermore, in each of the second turn on time interval that each of the low gray scale data group corresponds to, an luminance area (shown as voltage waveform in FIG. 5) that each of the low gray scale data group outputted sequentially corresponds to (i.e. luminance areas 56, 57) and 58, may have a constant time interval i therebetween. The time interval i may be equal to or greater than zero second, and is preferably 0.5 us. It should be noted that, FIG. 4 and FIG. 5 only schematically present the driving current and voltage of three light emitting diode channels. As for the schedule of driving current and the corresponding voltage of other channels, they are the same as channel 1 to channel 3 mentioned above, and their descriptions are not repeated herein.

As a result, when multiple gray scale data current of different channels are output in the same time interval, the luminance of low gray scale data may have a rise due to the influence of high gray scale data group as the rising luminance area 41 shown in FIG. 4. By contrast, due to the low gray scale currents 51, 52, and 53 being turned on in unit time intervals different from the unit time interval where the high gray scale data currents are turned on, and each of the turn on time intervals of current 51, 52, and 53 do not overlap each other (time interval i between each of them), the luminance area 56 shown in FIG. 5 does not rise because of the influence of other gray scale data currents as FIG. 4.

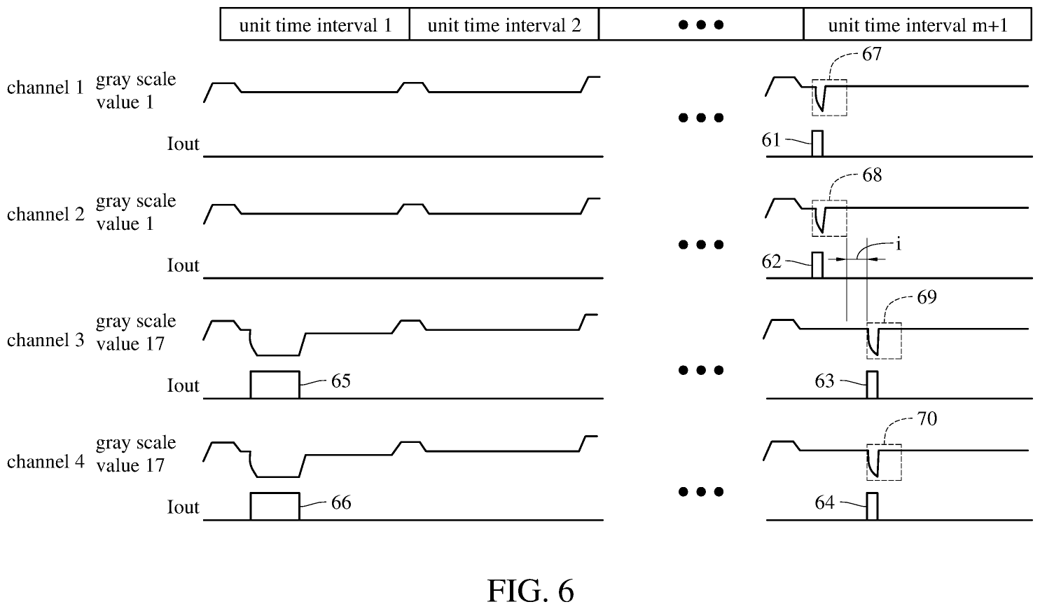

Please refer to FIG. 6, which is a timing diagram illustrating the interleaving driving method of light emitting diode array according to another embodiment of the present invention.

Same as FIG. 5, in the timing diagram illustrating the interleaving driving method of light emitting diode array according to another embodiment of the present invention shown in FIG. 6, current 61 of the low gray scale data corresponding to the gray scale value being 1 in channel 1, current 62 of the low gray scale data corresponding to the gray scale value being 1 in channel 2, current 63 of the low gray scale data corresponding to the gray scale value being 17 in channel 3, and current 64 of the low gray scale data in channel 4 corresponding to the gray scale value being 17 in channel 4 turn on in the unit time interval m+1 which is different from that of the high gray scale data currents 65 and 66. The difference is that currents 61 and 62 are outputted at the same second turn on time interval, and currents 63 and 64 are outputted at the same second turn on time interval. The luminance area (shown as voltage waveform in FIG. 6) corresponding to the low gray scale data current outputted at different second turn on time intervals, that is luminance areas 67,68 and luminance areas 69,70 may include a time interval i between them, wherein the time interval i may be equal or greater than zero second, preferably 0.5 us.

As a result, the luminance area corresponding to each of the low gray scale data in FIG. 6, that is luminance areas 67, 68, 69, and 70, the rising of the luminance areas 67 and 68 of channels 1 and 2 under the influence of each other is less significant than the rising caused by turning on four channels at the same time. Similarly, the rising of the luminance areas 69 and 70 of channels 3 and 4 under the influence of each other is less significant than the rising caused by turning on four channels at the same time

In summary, the present invention can reduce the color shift and light brighten of the low gray scale screen by the method of interleaving display the low gray scale data and the high gray scale data of the light emitting diode array, and thereby increasing the contrast ratio of the light emitting diode array.

What is claimed is:

1. An interleaving driving method of light emitting diode array, adapted to a light emitting diode array, the light emitting diode array including a plurality of light emitting diode channels, and the interleaving driving method comprising:
receiving an image signal;
converting the image signal into a plurality of gray scale signals, the plurality of gray scale signals correspond to the plurality of light emitting channels, respectively; and
using each of the plurality of gray scale signals as a target gray scale signal, execute:
generating a high gray scale data group and a low gray scale data group according to a preset threshold and the target gray scale signal;
when there is data in the high gray scale data group, drive the light emitting diode channel corresponding to the target gray scale signal among the plurality of light emitting diode channels during a first turn on time interval; and
when there is data in the low gray scale data group, drive the light emitting diode channel corresponding to the target gray scale signal during a second turn on time interval;
wherein the first turn on time interval does not overlap the second turn on time interval; and
wherein the plurality of gray scale signals includes a first gray scale signal and a second gray scale signal, the second turn on time interval corresponding to the first gray scale signal does not overlap the second turn on time interval corresponding to the second gray scale signal.

2. The interleaving driving method of claim 1, wherein the first turn on time interval corresponding to any one of the plurality of gray scale signals does not overlap the second turn on time interval corresponding to any one of the plurality of gray scale signals.

3. The interleaving driving method of claim 1, wherein the plurality of gray scale signals include a first gray scale signal and a second gray scale signal, a start timing of the first turn on time interval corresponding to the first gray scale signal is the same as a start timing of the first turn on time interval corresponding to the second gray scale signal.

4. The interleaving driving method of claim 1, wherein the generating the high gray scale data group and the low gray scale data group according to the preset threshold and the target gray scale signal comprises:
dividing the gray scale value of the target gray scale signal by the preset threshold value to generate quotient and residual;
generating the high gray scale data group by the quotient and the preset threshold value; and
generating the low gray scale data group by the residual value.

5. A light emitting diode device comprising:
a light emitting diode array, comprising a plurality of light diode channels;
a current driving circuit, electrically connected to the light emitting diode array; and
a processing control circuit, electrically connected to the current driving circuit, and is configured to receive an image signal, convert the image signal into a plurality of gray scale signals corresponding to the plurality of light diode channels, respectively, and uses each of the plurality of gray scale signals as a target gray scale signal to execute:
generating a high gray scale data group and a low gray scale data group according to a preset threshold and the target gray scale signal;
when there is data in the high gray scale data group, drive the light emitting diode channel corresponding to the target gray scale signal among the plurality of light emitting diode channels through the current driving circuit during a first turn on time interval; and
when there is data in the low gray scale data group, drive the light emitting diode channel corresponding to the target gray scale signal through the current driving circuit during a second turn on time interval;
wherein the first turn on time interval does not overlap the second turn on time interval; and
wherein the plurality of gray scale signals includes a first gray scale signal and a second gray scale signal, the second turn on time interval corresponding to the first gray scale signal does not overlap the second turn on time interval corresponding to the second gray scale signal.

6. The light emitting diode device of claim 5, wherein the first turn on time interval corresponding to any one of the plurality of gray scale signals does not overlap the second turn on time interval of any one of the plurality of gray scale signals.

7. The light emitting diode device of claim 5, wherein the plurality of gray scale signals include a first gray scale signal and a second gray scale signal, a start timing of the first turn on time interval corresponding to the first gray scale signal is the same as a start timing of the first turn on time interval corresponding to the second gray scale signal.

8. The light emitting diode device of claim 5, wherein the processing control circuit is configured to divide the gray scale value of the target gray scale signal by the preset threshold value to generate quotient and residual, generate the high gray scale data group by the quotient and the preset threshold value, and generate the low gray scale data group by the residual value.
